(19) United States
(12) Patent Application Publication
(10) Pub. No.: US 2026/0056581 A1
(43) Pub. Date: Feb. 26, 2026

(54) METHOD FOR PROVIDING SERVICE CONTINUITY, AND ELECTRONIC DEVICE THEREFOR

(71) Applicant: Samsung Electronics Co., Ltd., Suwon-si (KR)

(72) Inventors: Kwangtaek WOO, Suwon-si (KR); Jaeho CHOI, Suwon-si (KR); Mingyu KIM, Suwon-si (KR); Seonghun KIM, Suwon-si (KR); Jinwan AN, Suwon-si (KR)

(21) Appl. No.: 19/372,903

(22) Filed: Oct. 29, 2025

Related U.S. Application Data
(63) Continuation of application No. PCT/KR2024/008438, filed on Jun. 19, 2024.

(30) Foreign Application Priority Data
Jun. 24, 2023 (KR) 10-2023-0081517
Jul. 31, 2023 (KR) 10-2023-0099786

(51) Int. Cl. G06F 1/16; G06F 9/451

(52) U.S. Cl. CPC G06F 1/1647; G06F 1/1618; G06F 1/1652; G06F 9/451

(57) ABSTRACT

An electronic device is provided. The electronic device includes a foldable housing. This electronic device transitions from an unfolded position to a folded position while providing content through a front display in the unfolded position. The electronic device identifies a direction in which a display of the electronic device faces, on the basis of detecting the transition. The electronic device determines whether to provide the content, on the basis of whether the display direction before the transition corresponds to the display direction after the transition.

### CROSS-REFERENCE TO RELATED APPLICATION(S)

This application is a continuation application, claiming priority under 35 U.S.C. § 365 (c), of an International application No. PCT/KR2024/008438, filed on Jun. 19, 2024, which is based on and claims the benefit of a Korean patent application number 10-2023-0081517, filed on Jun. 24, 2023, in the Korean Intellectual Property Office, and of a Korean patent application number 10-2023-0099786, filed on Jul. 31, 2023, in the Korean Intellectual Property Office, the disclosure of each of which is incorporated by reference herein in its entirety.

### BACKGROUND

### 1. Field

The disclosure relates to a method for providing service continuity and an electronic device therefor.

### 2. Description of Related Art

A foldable electronic device is widely being used. The foldable electronic device may have a hinge structure and a housing that is foldable or unfoldable around the hinge structure. For user convenience, the foldable electronic device may include displays disposed on a plurality of surfaces. For example, the foldable electronic device may include a main display and a sub-display. For example, in an unfolded state, the foldable electronic device may provide a service by displaying content through the main display. When switched from the unfolded state to a folded state, the foldable electronic device may terminate displaying the content.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for providing service continuity and an electronic device therefor.

Additional aspects will be set forth in part in the description which follows and, in part, will be apparent from the description, or may be learned by practice of the presented embodiments.

In accordance with an aspect of the disclosure, an electronic device is provided. The electronic device includes a housing including a first housing and a second housing rotatably engaged with the first housing between a folded position and an unfolded position, a first flexible display visible from a front side of the housing in an unfolded position, a second display visible from a rear side of the housing at the unfolded position, at least one sensor circuitry configured to detect a transition between the folded position and the unfolded position of the housing and detect a direction of the housing, memory storing instructions, and at least one processor electrically communicatively coupled to the first flexible display, the second display, the at least one sensor circuitry, and the memory, wherein the instructions, when executed by the at least one processor individually or collectively, cause the electronic device to provide content corresponding to a first application through the first flexible display by executing the first application at the unfolded position, while providing the content through the first flexible display, detect a transition of the housing from the unfolded position to the folded position using the at least one sensor circuitry, identifying, based on the detecting of the transition, a second direction in which the second display is facing in the folded position, and based on the second direction corresponding to a first direction in which a front surface of the housing faces before the transition to the folded position, provide the content corresponding to the first application through the second display, based on the second direction not corresponding to the first direction, and maintain an execution state of the first application for a specified time interval.

In accordance with another aspect of the disclosure, a method of an electronic device with a housing including a first housing and a second housing rotatably engaged with the first housing is provided. The method includes providing content corresponding to the first application through a first flexible display visible from a front side of the housing by executing the first application at a unfolded position of the housing, detecting while providing the content through the first flexible display a transition of the housing from the unfolded position to a folded position, identifying, based on detection of the transition to the folded position, a second direction in which a second display disposed on a rear surface of the second housing faces in the folded position based on the second direction corresponding to a first direction in which a front surface of the housing faces before the transition to the folded position, and controlling the second display to a standby state or an off state and maintaining an execution state of the first application for a specified time interval.

In accordance with another aspect of the disclosure, one or more non-transitory computer-readable storage media storing one or more computer programs including computer-executable instructions that, when executed by one or more processors of an electronic device individually or collectively with a housing including a first housing and a second housing rotatably engaged with the first housing, cause the electronic device to perform operations are provided. The operations include providing content corresponding to a first application through a first flexible display visible from a front side of the housing at an unfolded position by executing the first application at the unfolded position of the housing, detecting a transition of the housing from the unfolded position to a folded position while providing the content through the first flexible display, based on detection of the transition to the folded position, identifying a second direction in which a second display disposed at a rear surface of the second housing faces in the folded position, based on the second direction corresponding to a first direction, in which a front surface of the housing faces before the transition to the folded position, providing content corresponding to the first application through the second display, and based on the second direction not corresponding to the first direction, controlling the second display to be in a standby state or an off-state, and maintaining an execution state of the first application for a specified time interval.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device according to an embodiment of the disclosure;

FIG. 2A illustrates an electronic device in an unfolded position according to an embodiment of the disclosure;

FIG. 2B illustrates an electronic device in a half-folded position according to an embodiment of the disclosure;

FIG. 2C illustrates an electronic device in a folded position according to an embodiment of the disclosure;

FIG. 3 illustrates a foldable electronic device according to an embodiment of the disclosure;

FIG. 4 illustrates a foldable electronic device according to an embodiment of the disclosure;

FIG. 5 is a flowchart of a service providing method according to an embodiment of the disclosure;

FIG. 6 illustrates sensor circuitry arrangement according to an embodiment of the disclosure;

FIG. 7 illustrates a position transition of an electronic device according to an embodiment of the disclosure;

FIG. 8 illustrates an example of an altitude change of an electronic device according to an embodiment of the disclosure;

FIG. 9 illustrates a gripped state of an electronic device according to an embodiment of the disclosure;

FIG. 10 is a flowchart of a continuous service providing method according to an embodiment of the disclosure;

FIG. 11 is a flowchart of a continuous service providing method according to an embodiment of the disclosure;

FIG. 12 illustrates one example of a transition to a half-folded position according to an embodiment of the disclosure;

FIG. 13 is a flowchart of a content providing method according to an embodiment of the disclosure; and

FIG. 14 is a block diagram of an electronic device in a network environment according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

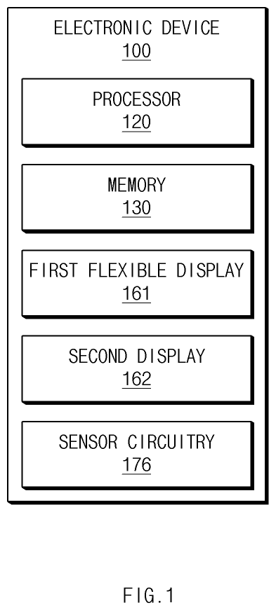

FIG. 1 is a block diagram of an electronic device according to an embodiment of the disclosure.

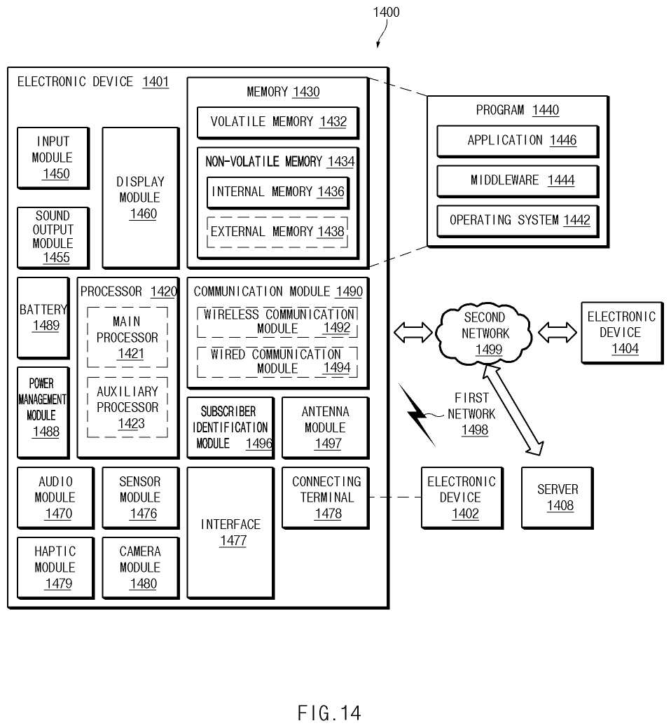

Referring to FIG. 1, according to an embodiment, the electronic device 100 may include a processor 120, memory 130, a first flexible display 161, a second display 162, and sensor circuitry 176. For example, the electronic device 100 may correspond to the electronic device 1401 of FIG. 14. The structure of the electronic device 100 illustrated in FIG. 1 is illustrative, and embodiments of the disclosure are not limited thereto. For example, the electronic device 100 may further include a component not illustrated in FIG. 1 (e.g., at least one component of the electronic device 1401 of 14). For example, the electronic device 100 may not include at least one of the components illustrated in FIG. 1.

The processor 120 may include at least one processing circuitry (e.g., at least one processor). For example, the processor 120 may control various components of the electronic device 100 to cause the electronic device to perform various operations. For example, the processor 120 corresponds to the processor 1420 of FIG. 14. For example, operations of the electronic device 100 described below may be referred to as operations performed by the processor 120. The processor 120 may perform various operations of the electronic device 100 by executing one or more instructions stored in the memory 130. The processor 120 may control the electronic device 100 to perform the various operations by executing the instructions stored in the memory 130. The processor 120 may include one processor or a plurality of processors. In an example, the processor 120 may be implemented as one chipset. The plurality of processors may be configured to individually or collectively execute instructions to perform the operations, which will be described below, of the electronic device 100.

The memory 130 may be implemented as one chip or a chipset with the processor 120. The memory 130 may be implementing as a separate chip from the processor 120. In an example, the memory 130 may correspond to the memory 1430 of FIG. 14. The memory 130 may store various information for operations of the electronic device 100. For example, the memory 130 may store instructions that may be executed by the processor 120. The memory may be configured to provide data required by the processor 120 and store data generated by the processor 120.

The first flexible display 161 and the second display 162 may include a plurality of pixels. For example, the first flexible display 161 and the second display 162 may correspond to the display module 1460 of FIG. 14. The first flexible display 161 and/or the second display 162 may include touch screens. The processor 120 may display images by using the first flexible display 161 and/or the second display 162.

The first flexible display 161 may be referred to as a display located on a front surface of the electronic device 100 in an unfolded position of the electronic device 100. The first flexible display 161 may also be a display configured to be folded or unfolded around a hinge structure of the electronic device 100. The first flexible display 161 may be referred to as a foldable display or a main display.

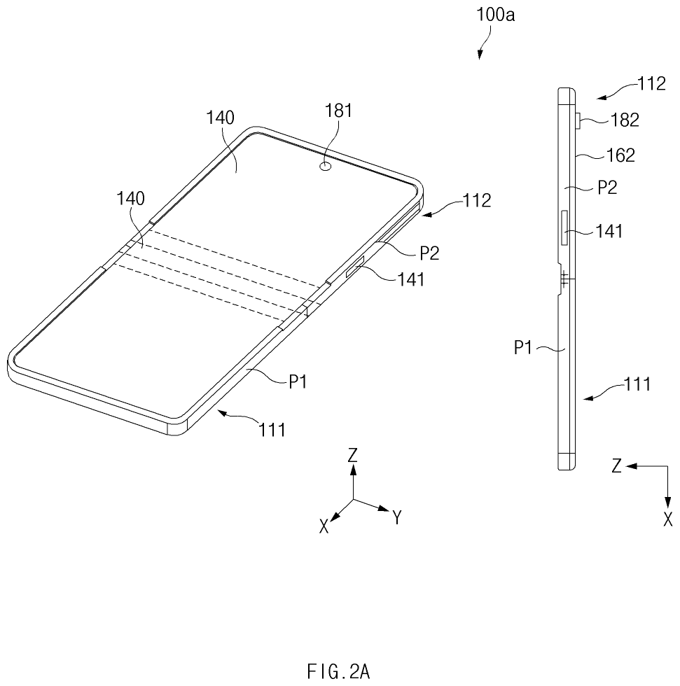

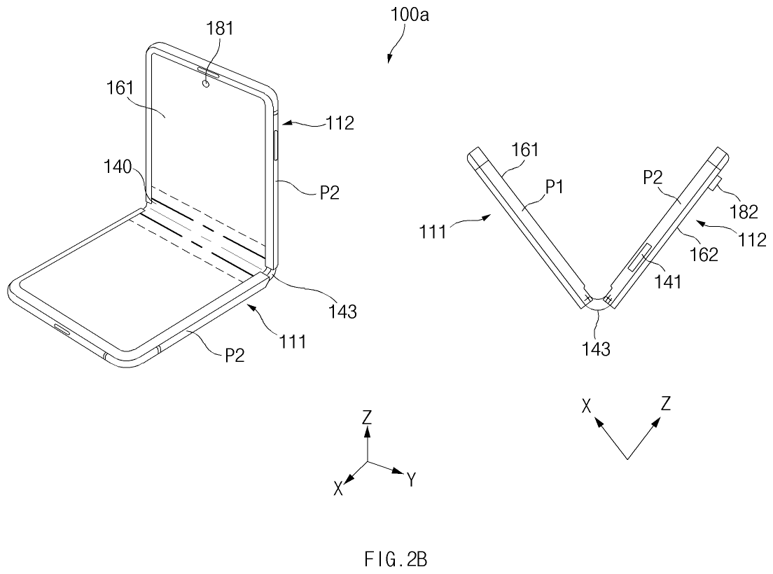

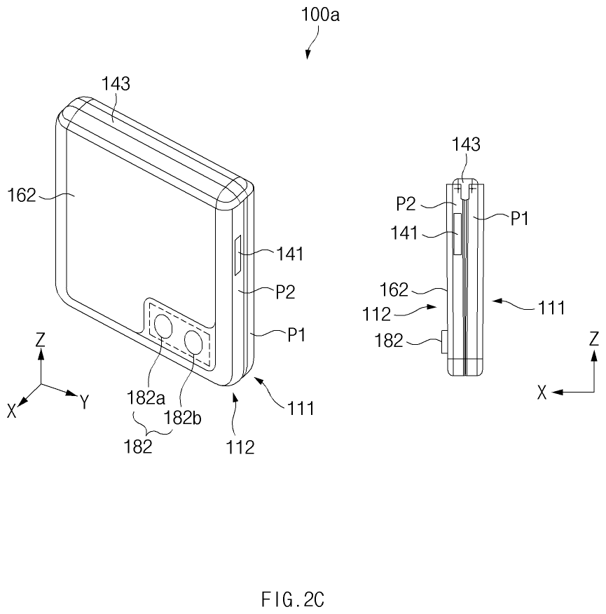

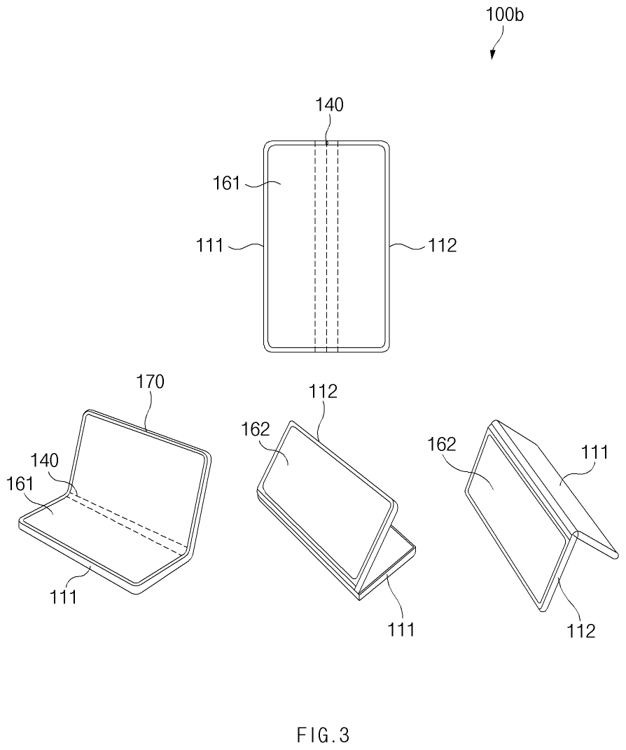

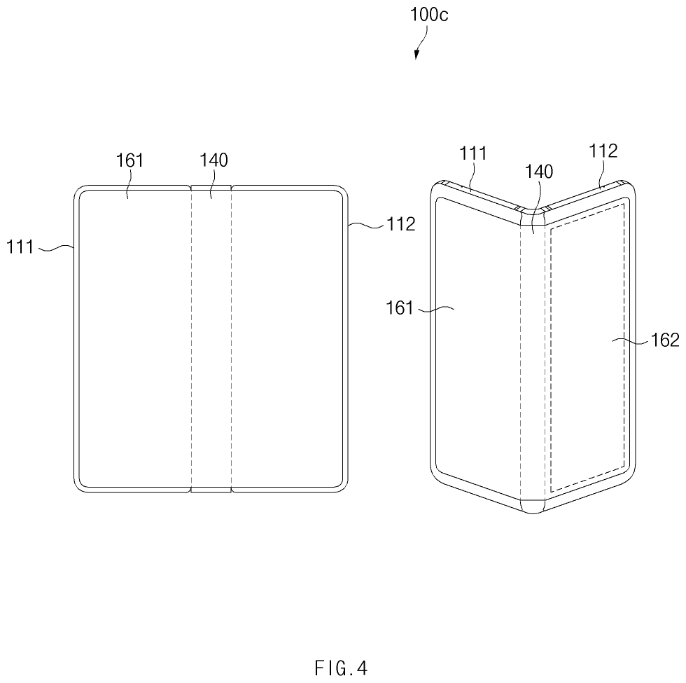

The second display 162 may be referred to as a display that is viewable from the outside of the electronic device 100 in a folded position of the electronic device 100. For example, the electronic device 100 may be an in-fold device (e.g., examples of FIGS. 2A to 2C, and 3). In this case, the first flexible display 161 may be folded such that a plurality of display areas divided around a hinge structure face each other. The second display 162 of the in-fold device may be a display located on a rear surface of the electronic device 100 in an unfolded position. For example, the electronic device 100 may be an out-fold device (e.g., an example of FIG. 4). In this case, the first flexible display 161 may be folded such that the plurality of display areas divided around the hinge structure face opposite directions. The second display 162 may be a partial display area of the first flexible display 161. The second display 162 may be referred to as a sub-display or a sub-display area of the main display.

The display 160 may include a plurality of pixels. For example, the display 160 may correspond to the display module 1460 of FIG. 14. The processor 120 may display a visual image using the display 160. In an example, the display 160 may include a touch screen display. As described above, the display 160 may be omitted.

The sensor circuitry 176 may include at least one sensor for identifying states of the electronic device 100. The sensor circuitry 176 may correspond to, for example, the sensor module 1476 of FIG. 14.

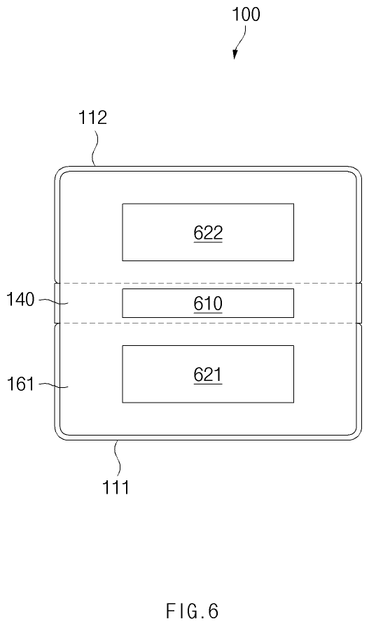

The sensor circuitry 176 may be configured to detect a folded state of the electronic device 100. For example, the sensor circuitry 176 may include at least one acceleration sensor, at least one gyro sensor, and/or at least one hinge sensor. The hinge sensor may be referred to as a sensor configured to detect a folding angle of the electronic device 100. The processor 120 may identify the folded state of the electronic device 100 using the sensor circuitry 176. A method for identifying the folded state may be described below with respect to FIG. 6. The sensor circuitry 176 may detect altitudes of the electronic device 110. For example, the sensor circuitry 176 may include at least one barometer. The sensor circuitry 176 may be configured to detect a grip state of the electronic device 100. For example, the sensor circuitry 176 may include at least one grip sensor. The grip sensor, for example, may be configured to detect an external grip of the electronic device 100 based on capacitance, detect an external grip of the electronic device 100 based on an impedance change of a conductor, or detect an external grip of the electronic device 100 based on a reflected signal.

For example, the electronic device 100 may include any electronic device with a foldable housing. The electronic device 100 may include, for example, at least one of a portable communication device (e.g., a smartphone), a computer device, a portable multimedia device, a portable medical device, a camera, a wearable device, an in-vehicle electronic device, or a home appliance. The electronic device according to an embodiment of the disclosure is not limited to the above-described devices. Hereinafter, various examples of the electronic device 100 may be described with reference to FIGS. 2A to 2C, 3, and 4.

FIG. 2A illustrates an electronic device in an unfolded position according to an embodiment of the disclosure.

FIG. 2B illustrates an electronic device in a half-folded position according to an embodiment of the disclosure.

FIG. 2C illustrates an electronic device in the folded position according to an embodiment of the disclosure.

Referring to FIGS. 2A, 2B, and 2C, the electronic device 100a according to an embodiment may include a structure in which the first housing 111 and the second housing 112 are rotatable in opposite directions through the folding area 140. For example, the electronic device 100a may correspond to the electronic device 100 of FIG. 1. The electronic device 100a may be configured to perform a folding operation (e.g., an operation of being deformed in the order of FIGS. 2A, 2B, and 2C) or an unfolding operation (e.g., an operation of being deformed in the order of FIGS. 2C, 2B, and 2A). For example, in the folding operation performed from the unfolded position (e.g., the state of FIG. 2A), the first housing 111 may rotate clockwise, and the second housing 112 may rotate counterclockwise. For example, the folding area 140 may include an area corresponding to an area in which a hinge structure of the electronic device 100a is located. For example, the second housing 112 may be configured to be movably or rotatably engaged with the first housing 111 between the folded position and the unfolded position.

Based on the unfolded position (e.g., the state of FIG. 2A) of the electronic device 100a, a first edge surface P1, which is a surface of a side surface of the first housing 111 facing the same direction as a direction in which the fingerprint contact surface of the fingerprint sensor 141 faces, may be defined. A second edge surface P2, which is a surface of a side surface the second housing 112 facing the same direction as the direction in the direction in which the fingerprint contact surface of a fingerprint sensor 141 faces, is defined. For example, the first edge surface P1 may include a portion of the first housing 111, and the second edge surface P2 may include a portion of the second housing 112 and a portion of the fingerprint sensor 141 located at the second housing 112.

Referring to FIG. 2A, the unfolded position may mean a state in which the folding area 140 of the first flexible display 161 is substantially flat. For example, the unfolded position may be referred to as a state in which an angle between the first housing 111 and the second housing 112 is equal to or greater than a specified first angle (e.g., 120 degrees). For example, the unfolded position may include a state in which the first edge surface P1 and the second edge surface P2 substantially form one surface. For example, the unfolded position may include a state in which the first flexible display 161 and the second display 162 face in opposite directions and are parallel to each other. For example, the electronic device 100a in the unfolded position may display an image obtained using a rear camera 182 on the first flexible display 161.

Referring to FIG. 2B, the half-folded position (or, an intermediate state) may mean any state between the unfolded position and the folded position. For example, the half-folded position may be referred to as a state in which an angle between the first housing 111 and the second housing 112 is less than a specified first angle (e.g., 120 degrees) and equal to or greater than a specified second angle (e.g., 30 degrees). In the half-folded position, an operation mode of the electronic device 100a may be referred to as a table mode or a flex mode. For example, the half-folded position can be referred to as a state excluding the folded position and the unfolded position. For example, the half-folded position may include a state in which the folding area 140 of the first flexible display 161 is a curved surface. For example, the half-folded position includes a state in which a lengthy portion of the first edge surface P1 and a lengthy portion of the second edge surface P2 form a predetermined angle that is not 180 degrees. For example, the electronic device 100a in the half-folded position may display an image obtained by using a camera module (e.g., a front camera 181 or the rear camera 182) on a partial area of the first flexible display 161.

Referring to FIG. 2C, the folded position may include a state in which a curved surface formed by the folding area 140 of the first flexible display 161 has a greater curvature than a curved surface formed by the folded area 140 in the half-folded position. For example, the folded position may be referred to as a state in which an angle between the first housing 111 and the second housing 112 is less than a specified second angle (e.g., 30 degrees). For example, the folded position may mean a state in which the first edge surface P1 and the second edge surface P2 are substantially in contact with each other among a plurality of folded positions.

In the folded position, the first flexible display 161 may not be viewable from the outside of the electronic device 100a. In the folded position, the second display 162 may be viewable from the outside of the electronic device 100a. For example, the electronic device 100a in the folded position may display an image obtained by using the rear camera 182 (e.g., a first rear camera 182a and/or a second rear camera 182b) on at least a portion of the second display 162.

According to an embodiment, at least a portion of the hinge part 143 may form an outer appearance (or, a surface) of the electronic device 100 in the half-folded position and the unfolded position. For example, as illustrated in FIGS. 2B and 2C, the hinge part 143 may be visually exposed between the first housing 111 and the second housing 112 when the electronic device 100a is in the half-folded position or the folded position.

FIG. 3 illustrates a foldable electronic device according to an embodiment of the disclosure.

Referring to FIG. 3, an electronic device 100b may correspond to the electronic device 100 of FIG. 1. With reference to FIGS. 2A to 2C, the electronic device 100a in which a hinge structure is formed along a short axis has been described. In the example of FIG. 3, the hinge structure may be formed along a long axis of the electronic device 100b The electronic device 100b may be folded or unfolded about the folding area 140. The electronic device 100a of FIGS. 2A to 2C, and 3 to 20 and the electronic device 100b of FIG. 3 are in-fold devices, and contents described above with reference to FIGS. 2A to 2C may also be applied to the electronic device 100b of FIG. 3.

FIG. 4 illustrates a foldable electronic device according to an embodiment of the disclosure.

Referring to FIG. 4, the electronic device 100c may correspond to the electronic device 100 of FIG. 1. For example, the electronic device 100c can be an out-folded device. In the unfolded position, the first flexible display 161 may be visible through the front surfaces of the first housing 111 and the second housing 112. In the folded position, the first housing 111 and second housing 112 may face each other. In the folded position, the second display 162 may be visible through one surface of the electronic device 100c. For example, the second display 162 may include a partial display area of the first flexible display 161. The second display 162 may include one area of the first flexible display 161 divided by the folding area 140. For example, the second display 162 may be a display area located at the second housing 112. For example, the second display 162 may include a display area in which a camera (not shown) of the electronic device 100c is located among the display areas (e.g., areas defined by the folding area 140) of the first flexible display 161.

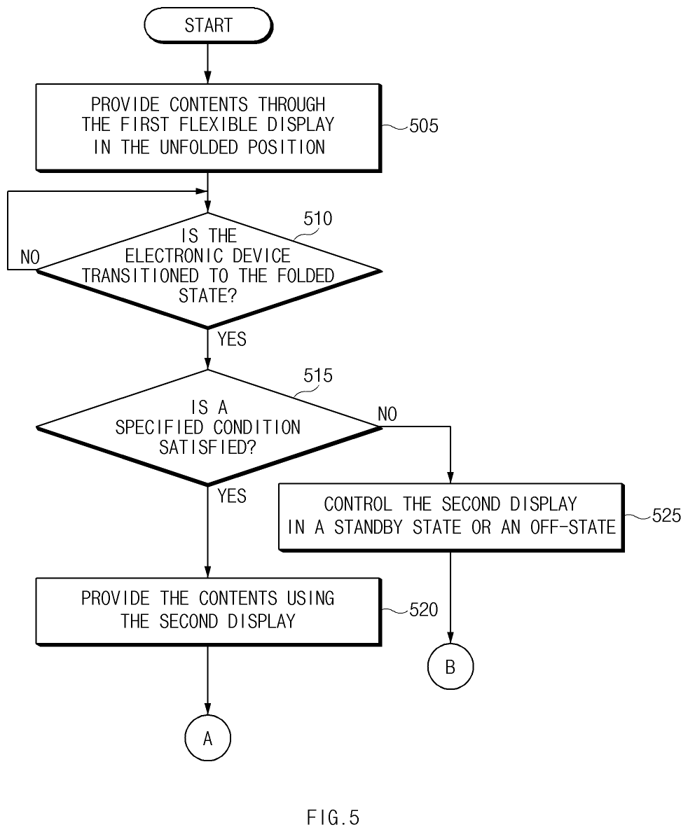

FIG. 5 is a flowchart of a service providing method according to an embodiment of the disclosure.

Referring to FIGS. 1 and 5, according to an embodiment, the electronic device 100 may provide service continuity when a state of the electronic device 100 is transitioned. For example, the electronic device 100 may provide the service continuity based on at least one of a direction that a display of the electronic device 100 faces, an altitude of the electronic device 100, a gripping state of the electronic device 100, a direction of a user with respect to the electronic device 100, an execution state of an application being executed, or a type of the application being executed. The service continuity may mean continuously providing a service provided in a previous state when a state of the electronic device 100 changes. The electronic device 100 may provide a service by providing content of an application executed on the electronic device 100. For example, the content may include an execution screen of the application being executed and/or a sound of the application being executed.

In operation 505, the electronic device 100 may provide contents through the first flexible display 161 in the unfolded position. For example, the electronic device 100 may display an execution screen of a first application being executed in the electronic device 100 on the first flexible display 161.

In operation 510, the electronic device 100 may determine whether the electronic device 100 has transitioned to the folded position. For example, the electronic device 100 may use the sensor circuitry 176 to determine whether the electronic device 100 transitions from the unfolded position to the folded position. A method of detecting the position transition of the electronic device 100 may be described below with reference to FIG. 6. When the electronic device 100 has not transitioned to the folded position (e.g., the operation 510-NO), the electronic device 100 may monitor the position transition.

When the electronic device 100 is transitioned to the folded position (e.g., the operation 510—YES), in operation 515, the electronic device 100 may determine whether a specified condition is satisfied. For example, the specified condition may include at least one of an orientation of the electronic device 100, a change in altitudes of the electronic device 100, the gripping state of the electronic device 100, a direction of the user with respect to the electronic device 100, an execution state of an application being executed, a block state of a display, or a type of the application being executed.

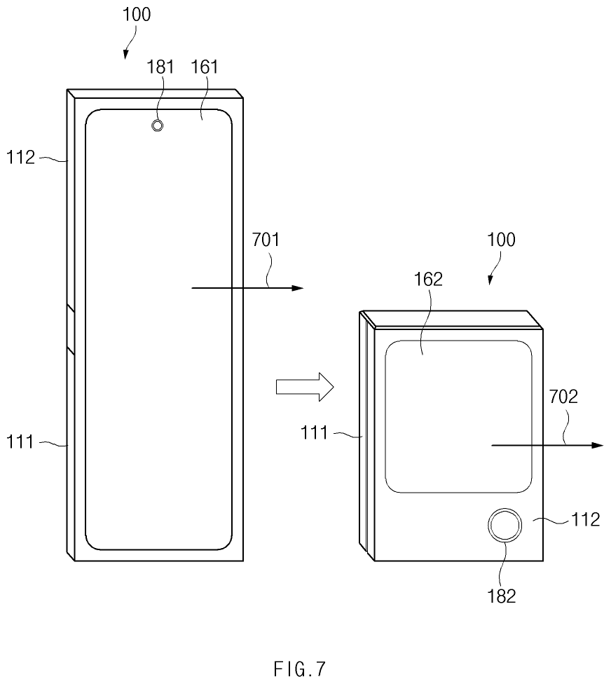

In an example, the electronic device 100 may identify a first direction (e.g., a direction substantially perpendicular to a display surface of the first flexible display 161) that the first flexible display 161 is facing in the unfolded position by using the sensor circuitry 176. The electronic device 100 may identify a second direction (e.g., a direction that is substantially perpendicular to a display surface of the second display 162) that the second display 162 is facing in the folded position. When the first direction corresponds to the second direction, the electronic device 100 may determine that the specified condition is satisfied. When an angle between the first direction and the second direction is within the specified angle, the first direction may correspond to the second direction. When the first direction and the second direction are substantially identical, the first direction may correspond to the second direction. Determination of whether the specified condition is satisfied based on the direction of the electronic device 100 may be described below with reference to FIG. 7.

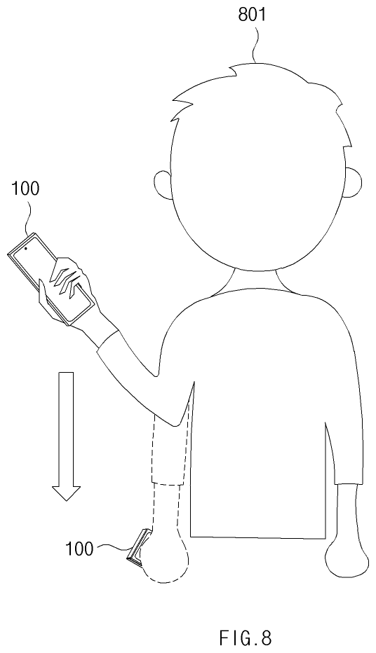

In an example, when the change in altitudes of the electronic device 100 is less than a specified value, it may be determined that the specified condition is satisfied. When the difference between an altitude of the electronic device 100 in the unfolded position and an altitude of the electronic device 100 in the folded position is equal to or greater than the specified value, the electronic device 100 may determine that the specified condition is not satisfied. The condition related to the change in altitudes may be an exception condition. For example, even if other conditions (the direction of the electronic device 100, the gripping state of the electronic device 100, the direction of the user with respect to the electronic device 100, the execution state of an application being executed, the block state of the display, or the type of the application being executed) are satisfied, the electronic device 100 may be determined that the specified condition has not been satisfied when the altitude condition is not satisfied. Determination of whether the specified condition is satisfied based on the altitude of the electronic device 100 may be described below with reference to FIG. 8.

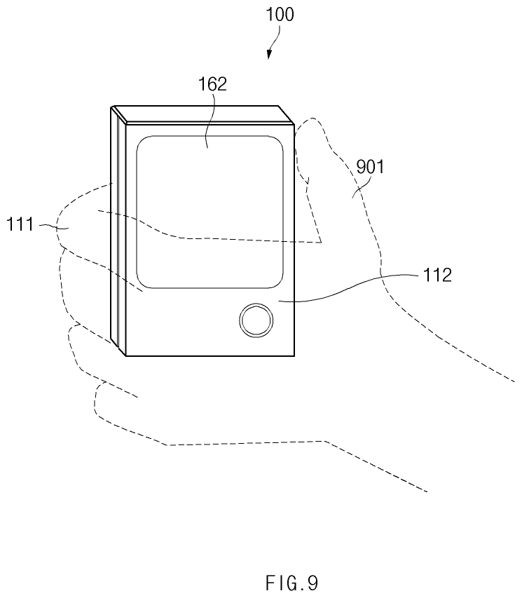

In an example, the electronic device 100 may determine whether the specified condition is satisfied based on the gripping state of the electronic device 100. In the folded position, the electronic device 100 may detect a surface on which the electronic device 100 is gripped. For example, when at least a portion of a surface on which the second housing (e.g., the second housing 112 of FIGS. 2A, 3, and 4) of the electronic device 100 or at least a portion of a surface on which the second display 162 is visible is gripped, the electronic device 100 may determine that the specified condition is not satisfied. The condition for gripping may be an exception condition. For example, even if other conditions (the direction of the electronic device 100, the altitude of the electronic device 100, the direction of the user with respect to the electronic device 100, the execution state of the application being executed, the block state of the display, or the type of the application being executed) are satisfied, if the gripping condition is not satisfied, the electronic device 100 may determine that the specified condition is not satisfied. Determination of whether the specified condition is satisfied based on gripping of the electronic device 100 may be described below with reference to FIG. 9.

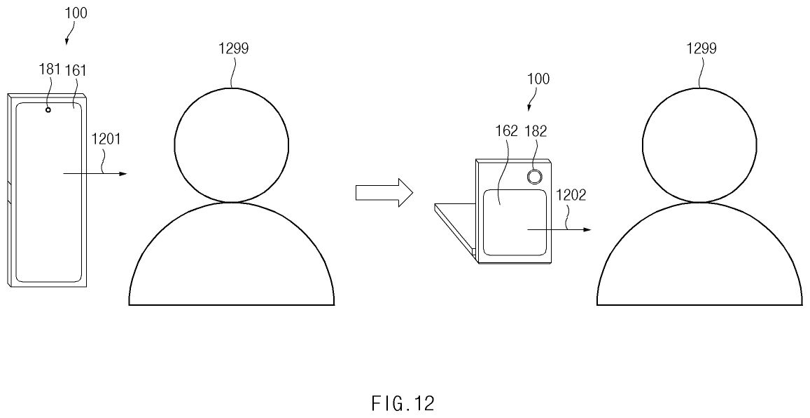

In an example, the electronic device 100 may determine whether the specified condition is satisfied based on the direction of the user with respect to the electronic device 100. For example, the electronic device 100 may detect the user in the folded position using a camera. Based on the sensing of the user, the electronic device 100 may identify a first direction of the user with respect to the electronic device 100. After the transition to the unfolded position, the electronic device 100 may detect the user using the camera. When a second direction of the user sensed in the folded position corresponds to the first direction of the user sensed in the unfolded position, the electronic device 100 may determine that the specified condition is satisfied. When an angle between the first direction and the second direction is within a specified angle, the first direction may correspond to the second direction. When the first direction and the second direction are substantially identical, the first direction may correspond to the second direction. The determination of whether the specified condition is satisfied based on the direction of the user may be described below with reference to FIG. 12.

In an example, the electronic device 100 may determine whether the specified condition is satisfied based on the execution state of the application being executed. The electronic device 100 may determine that the specified condition is satisfied when the execution state of the application in the unfolded position is a specified state. For example, when the execution state is a state in which an input interface (e.g., a virtual keyboard) for a user input is activated, the electronic device 100 may determine that the specified condition is satisfied after the transition to the folded position.

In an example, the electronic device 100 may determine whether the specified condition is satisfied based on the block state of the display. The electronic device 100 may determine that the specified condition is not satisfied in case that the second display 162 is blocked in the unfolded position. The electronic device 100 may determine that the specified condition is satisfied in case that the second display 162 is not blocked in the unfolded position. The electronic device 100 may identify whether the second display 162 is blocked using the sensor circuitry 176. In an example, the sensor circuitry 176 may include a proximity sensor located at a second housing (e.g., the second housing 112 of FIGS. 2A and 3). The electronic device 100 may identify whether a display surface, where the second display 162 faces, is blocked by an external object using the proximity sensor. The condition for blocking the display may be an exception condition. For example, even if other conditions (the direction of the electronic device 100, the altitude of the electronic device 100, the direction of a user with respect to the electronic device 100, the execution state of an application being executed, the type of the application being executed) are satisfied, the electronic device 100 may determine the specified condition is not satisfied if the condition for blocking is not satisfied.

For example, the electronic device 100 may determine whether the specified condition is satisfied based on the type of the application being executed in the electronic device 100. The application being executed may be referred to as an application being executed in a foreground of the electronic device 100. In case that the application being executed is a specified application (e.g., a camera application), the electronic device 100 may determine that the specified condition is satisfied.

In an example, the electronic device 100 may determine whether the specified condition is satisfied by combining at least some of the above-described conditions. For example, the electronic device 100 may determine that the specified condition is satisfied when all of the exception conditions (e.g., the altitude change of the electronic device 100, the gripping state of the electronic device 100, and the blocking state of the display) are satisfied and at least one of the remaining conditions (e.g., the direction of the electronic device 100, the direction of the user with respect to the electronic device 100, the execution state of the running application, or the type of the running application) is satisfied.

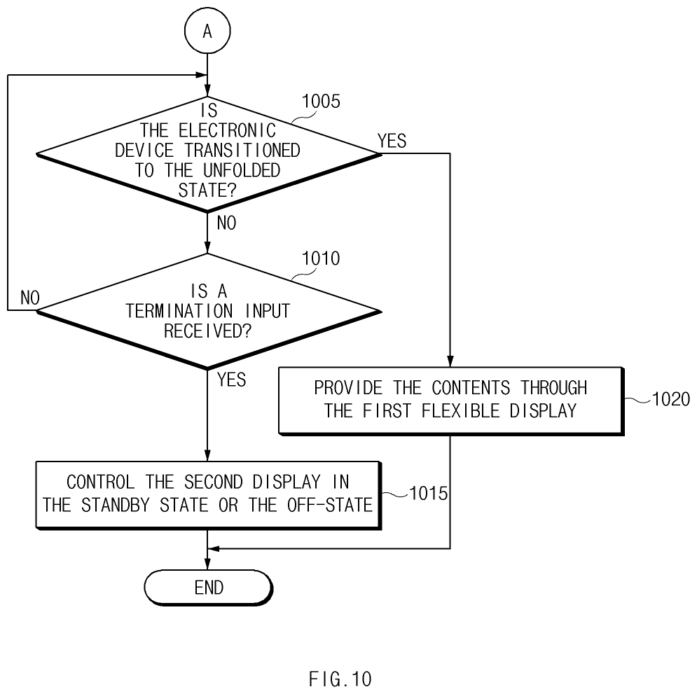

When the specified condition is satisfied (e.g., the operation 515—YES), in operation 520, the electronic device 100 may provide the contents using the second display 162. Even after the transition to the folded position, the electronic device 100 may continue to provide service continuity by providing the contents using the second display 162. The user of the electronic device 100 may continue to use the service provided in the unfolded position without a separate user input. In this case, a separate user input for continuous service of the electronic device 100 may be reduced. Due to the reduction in the input, usability of the user may be improved. By providing the service continuity based on the specified condition, the service corresponding to an intention of the user may be provided. After the content provision (e.g., the operation 520), the electronic device 100 may perform operations according to the reference point A. The operations according to the reference point A may be described below with reference to FIG. 10.

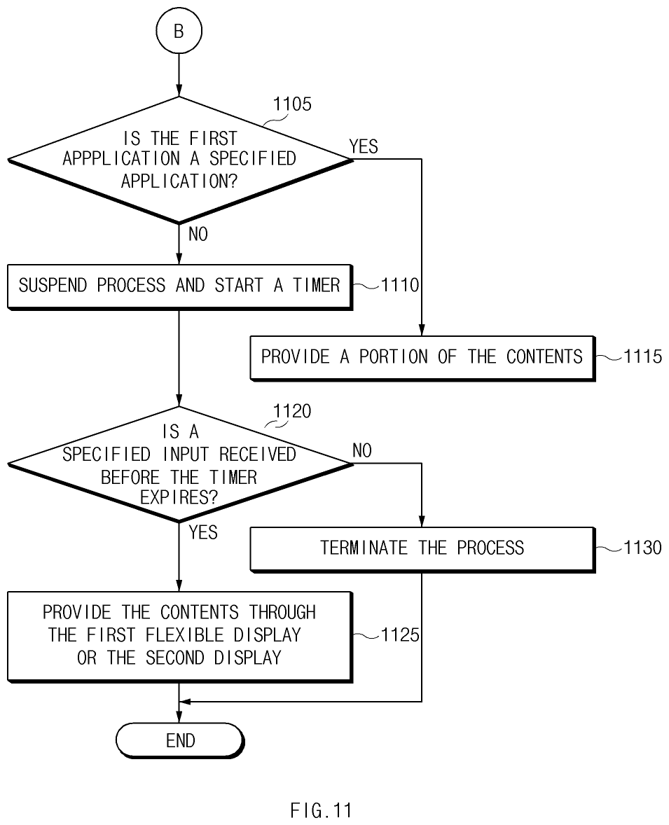

When the specified condition is not satisfied (e.g., the operation 515-NO), in operation 525, the electronic device 100 may control the second display 162 to a standby state or an off-state. The standby state may be referred to as a state in which the second display 162 is controlled to have a relatively low luminance (e.g., a luminance less than a specified luminance). In the standby state, the electronic device 100 may display an image on the second display 162 at a low luminance. The standby state may be referred as a low power state. The off-state may be referred to as a state of not displaying an image through the second display 162. After controlling the second display 162 (e.g., the operation 525), the electronic device 100 may perform operations according to the reference point B. The operations according to the reference point B may be described below with reference to FIG. 11.

FIG. 6 illustrates a sensor circuitry arrangement according to an embodiment of the disclosure.

Referring to FIGS. 1 and 6, according to an embodiment, the sensor circuitry 176 may include a plurality of sensors. For example, the sensor circuitry 176 may include at least one of a first inertial sensor 621, a second inertial sensor 622, or an angle sensor 610.

Each of the first inertial sensor 621 and the second inertial sensor 622 may include at least one gyro sensor and/or at least one acceleration sensor. The first inertial sensor 621 may be located in the first housing 111. The electronic device 100 may sense an orientation of the first housing 111 or the first flexible display 161 by using the first inertial sensor 621. The second inertial sensor 622 may be located in the second housing 112. The electronic device 100 may detect an orientation of the second housing 112, the first flexible display 161, or the second display 162 by using the second inertial sensor 622. In the disclosure, “orientation” may be referred to as a direction relative to a direction of gravity acceleration.

The angle sensor 610 may be configured to identify an angle between the first housing 111 and the second housing 112. For example, the angle sensor 610 may identify the angle between the first housing 111 and the second housing 112 by sensing rotation of a gear in the hinge structure located at the folding area 140. For example, the angle sensor 610 may identify the angle between the first housing 111 and the second housing 112 based on a magnetic force. The angle sensor 610 may include a magnetic source located in one of the first housing 111 and the second housing 112, and a magnetic force sensor (e.g., a Hall integrated circuit (IC)), located in other one of first housing 111 and the second housing 112, configured to sense a magnetic force. The angle sensor 610 may measure the angle between the first housing 111 and the second housing 112 by sensing the magnetic force from the magnetic source using the magnetic force sensor.

In an example, one of the first inertial sensor 621 or the second inertial sensor 622 may be omitted. For example, when the second inertial sensor 622 is omitted, the electronic device 100 may identify the orientation of the second housing 112 based on the orientation of the first housing 111 measured by the first inertial sensor 621 and the angle sensed by the angle sensor 610.

In an example, the angle sensor 610 may be omitted. For example, the electronic device 100 may identify the angle between the first housing 111 and the second housing 112 by comparing the orientation of the first housing 111 measured by the first inertial sensor 621 and the orientation of the second housing 112 measured by the second inertial sensor 622.

According to an embodiment, the electronic device 100 may detect a state transition of the electronic device 100 using the sensor circuitry 176 (e.g., the operation 510 of FIG. 5). For example, the electronic device 100 may sense a transition from the unfolded position to the folded position by identifying a change in the angle between the first housing 111 and the second housing 112. For example, the electronic device 100 may sense a transition from the unfolded position to the folded position by detecting a change in orientation of at least one of the first housing 111 or the second housing 112.

FIG. 7 illustrates a position transition of the electronic device according to an embodiment of the disclosure.

Referring to FIGS. 1 and 7, the electronic device 100 may be transitioned from the unfolded position to the folded position. In an embodiment, the electronic device 100 in the unfolded position may identify a first direction 701 using the sensor circuitry 176. For example, the electronic device 100 may identify the first direction 701 according to the methods described above with respect to FIG. 6. The first direction 701 may be referred to as a direction (e.g., a direction substantially perpendicular to a display surface of the first flexible display 161) where the first flexible display 161 faces in the unfolded position. The first direction 701 may be referred to as a direction that the front camera 181 faces.

In an embodiment, the electronic device 100 in the folded position may identify the second direction 702 using the sensor circuitry 176. For example, the electronic device 100 may identify the second direction 702 (e.g., a direction substantially perpendicular to a display surface of the second display 162) according to the methods described above with respect to FIG. 6. The second direction 702 may be referred to as a direction that the second display 162 faces in the folded position. The second direction 702 may be referred to as a direction that the rear camera 182 faces.

According to an embodiment, the electronic device 100 may use the sensor circuitry 176 to identify display directions before and after the transition. For example, the electronic device 100 may detect the first direction 701 at a first time point at which the transition from the unfolded position to the folded position starts. The electronic device 100 may detect the start of the transition based on a change in orientation or a change in angle. At the first time point at which the transition starts, the electronic device 100 may identify the first direction 701 in which the first flexible display 161 faces in the unfolded position. The electronic device 100 may identify the first direction 701 using the sensor circuitry 176 (e.g., the first inertial sensor 621 and/or the second inertial sensor 622 of FIG. 6). For example, the electronic device 100 may detect the second direction at a second time point at which the transition to the folded position is completed. The electronic device 100 may sense completion of the transition based on the orientation or angle of the housing. At the second time point at which the transition is completed, the electronic device 100 may identify the second direction 702 in which the second display 162 faces in the folded position. The electronic device 100 may identify the second direction using the first inertial sensor 601 or the second inertial sensor 602.

The electronic device 100 may determine whether a specified condition is satisfied based on the first direction and the second direction (e.g., operation 515 of FIG. 5). For example, when the first direction 701 corresponds to the second direction 702, the electronic device 100 may determine that the specified condition is satisfied. When an angle between the first direction 701 and the second direction 702 is within a specified angle, the first direction 701 may correspond to the second direction 702. When the first direction 701 and the second direction 702 are substantially identical, the first direction 701 may correspond to the second direction 702.

FIG. 8 illustrates an example of an altitude change of an electronic device according to an embodiment of the disclosure.

Referring to FIGS. 1 and 8, according to an embodiment, the electronic device 100 may determine whether a specified condition is satisfied based on a change in altitude of the electronic device (e.g., operation 515 of FIG. 5). For example, the electronic device 100 may sense the change in altitude of the electronic device 100 using a barometer or an altimeter included in the sensor circuitry 176.

For example, the electronic device 100 may detect a first altitude of the electronic device 100 at a first time point at which a transition from the unfolded position to the folded position starts. The electronic device 100 may detect the start of the transition based on a change in orientation or a change in angle. At the first time point at which the transition starts, the electronic device 100 may sense the first altitude of the electronic device 100 in the unfolded position. For example, the electronic device 100 may sense a second altitude at a second time point at which the transition to the folded position is completed.

The electronic device 100 may determine whether the specified condition is satisfied based on the first altitude and the second altitude (e.g., the operation 515 of FIG. 5). For example, when a difference between the first altitude and the second altitude is less than a specified value, the electronic device 100 may determine that the specified condition is satisfied. When the difference between the first altitude and the first altitude is equal to or greater than the specified value, the electronic device 100 may determine that the specified condition is not satisfied. A large altitude change before and after the state transition of the electronic device 100 may mean that the user 801 does not intend to use the electronic device 100. In an example, the condition for the variation in altitude may be an exception condition. For example, when the condition for the variation in altitude is satisfied and at least one of the remaining conditions (e.g., the direction of the electronic device 100, the direction of the user with respect to the electronic device 100, the execution state of the running application, or the type of the executed application) is satisfied, the electronic device 100 may determine that the specified condition is satisfied

With reference to FIG. 8, a method for detecting an altitude change by detecting an altitude has been described above, but embodiments of the disclosure are not limited thereto. According to an embodiment, the electronic device 100 may determine whether the specified condition is satisfied (e.g., operation 515 of FIG. 5) based on an acceleration change of the electronic device 100. For example, the electronic device 100 may detect the acceleration change of the electronic device 100 by using an accelerometer in the sensor circuitry 176. For example, the electronic device 100 may detect the acceleration change of the electronic device 100 from a first time point at which a transition from an unfolded position to a folded position starts. When a user holds the electronic device 100 down, the electronic device 100 may sense the acceleration change. For example, the electronic device 100 may detect the above-described altitude change based on the acceleration change. For example, by detecting the acceleration change on a time domain, the electronic device 100 may identify the altitude change of the electronic device 100. As described above, the electronic device 100 may determine whether the specified condition is satisfied (e.g., the operation 515 of FIG. 5) based on the altitude change.

In an example, the electronic device 100 may determine whether the specified condition is satisfied (e.g., the operation 515 of FIG. 5) based on an amount of acceleration change. For example, when the user holds the electronic device 100 down or places the electronic device 100 on a desk, the acceleration change may occur for a predetermined time, and then the acceleration change may disappear. The electronic device 100 may determine that the specified condition is satisfied when a pattern of the acceleration change detected from the first time point corresponds to the above-described example (e.g., when the electronic device 100 is held down or placed on a desk). In an example, the condition for the acceleration may be an exception condition. For example, when the condition for the acceleration is satisfied and at least one of the remaining conditions (e.g., the direction of the electronic device 100, the direction of the user with respect to the electronic device 100, the execution state of the application being executed, or the type of the application being executed) is satisfied, the electronic device 100 may determine that the specified condition is satisfied.

FIG. 9 illustrates a gripped state of an electronic device according to an embodiment of the disclosure.

Referring to FIGS. 1 and 9, according to an embodiment, the electronic device 100 may determine whether a specified condition is satisfied (e.g., operation 515 of FIG. 5) based on the gripping of the electronic device. For example, the electronic device 100 may detect the gripping state of the electronic device 100 by using a grip sensor included in the sensor circuitry 176. For example, the electronic device 100 may detect the gripping state by using the sensor circuitry 176 at a time point at which the transition from the unfolded position to the folded position is completed. For example, the sensor circuitry 176 may radiate a signal by using an antenna and may detect the gripping state by detecting a reflected signal. For example, the sensor circuitry 176 may detect the gripping state by detecting a change in capacitance. In an example, the electronic device 100, may detect the gripping state of the second display 162 by using touch circuitry of the second display 162. For example, a surface gripped by the user 901 may be referred to as a surface of the housing on which the gripping is detected on a relatively greater surfaces among the first housing 111 and the second housing 112.

In an example, the electronic device 100 may determine whether the specified condition is satisfied based on the gripping state of the electronic device 100. In the folded position, the electronic device 100 may detect a surface on which the electronic device 100 is gripped. For example, when at least a portion of a surface on which the second housing 112 or the second display 162 of the electronic device 100 is visible is gripped, the electronic device 100 may be determined that the specified condition is not satisfied. The condition for gripping may be an exception condition. For example, if the gripping condition is not satisfied, even if other conditions (e.g., the direction of the electronic device 100, the altitude of the electronic device 100, the direction of the user with respect to the electronic device 100, the execution state of the application being executed, the block state of the display, or the type of the application being executed) are satisfied, the electronic device 100 may determine that the specified condition is not satisfied.

FIG. 10 is a flowchart of a continuous service providing method according to an embodiment of the disclosure.

Referring to FIGS. 1 and 10, the electronic device 100 may perform operations of FIG. 10 after continuously providing contents (e.g., the operation 520 of FIG. 5).

In operation 1005, the electronic device 100 may determine whether the electronic device 100 is transitioned to the unfolded position. For example, the electronic device 100 may use the sensor circuitry 176 to determine whether the transition is occurred. When transitioned to the unfolded position (e.g., the operation 1005—YES), in operation 1020, the electronic device 100 may provide contents through the first flexible display 161. When the electronic device 100 transitions to the unfolded position in a situation in which a service is being provided in the folded position, the intention of the user may include providing contents through the first flexible display 161.

When the transition to the unfolded position is not performed (e.g., the operation 1005—NO), in operation 1010, the electronic device 100 may determine whether a termination input is received. For example, when an input to a physical button of the electronic device 100 is received, the electronic device 100 may determining that the termination input is received. In an example, when the operation 520 of FIG. 5 is performed, the electronic device 100 may display a user interface (e.g., an icon or a button) for terminating contents provision on one area of the second display 162. When an input to the user interface is received, the electronic device 100 may determine that the termination input is received. In an example, the electronic device 100 may display the user interface for the termination only for a specified time after the transition to the folded position. When the termination input is not received (e.g., the operation 1010—NO), the electronic device 100 may monitor state transition and whether the termination input is received.

When the termination input is received (e.g., the operation 1010—YES), in operation 1015, the electronic device 100 may control the second display 162 to be in the standby state or the off-state. In this case, the electronic device 100 may end the application being executed or may execute the application in the background.

FIG. 11 is a flowchart of a continuous service providing method according to an embodiment of the disclosure.

Referring to FIGS. 1 and 11, the electronic device 100 may perform operations of FIG. 11 after controlling the second display 162 (e.g., the operation 525 of FIG. 5).

In operation 1105, the electronic device 100 may determine whether the first application is a specified application. For example, the specified application may be an application that provides multimedia contents (e.g., a video playback application, a video streaming application, or a game application, etc.). The multimedia contents may be referred to as contents including audio contents and video contents. In an example, the specified application may include an application designated by a user or a manufacturer. In an example, operation 1105 may be omitted. In this case, operation 1105 and operation 1115 may be omitted from the operations of FIG. 11.

When the first application is the specified application (e.g., the operation 1105—YES), in operation 1115, the electronic device 100 may provide a portion of the contents. For example, the electronic device 100 may maintain an execution state of the first application, but may stop providing an execution screen or lower an execution performance. For example, the electronic device 100 may execute the first application in the background.

For example, in case that the first application is a video playback application or a video streaming application, the electronic device 100 may provide audio contents among the contents of the first application. The electronic device 100 may control the second display 162 to be in the standby state or the off-state, and may not provide the execution screen of the first application.

For example, in case that the first application is a game application, the electronic device 100 may provide the execution screen of the first application with a low brightness. For example, the electronic device 100 may display the execution screen on the second display 162 in the standby state. In this case, the electronic device 100 may release a priority mode (e.g., a processing performance enhanced mode for game applications) for the first application.

When the first application is not the specified application (e.g., the operation 1105—NO), in operation 1110, the electronic device 100 may suspend the process of the first application and start a timer. The suspension of the process may mean a state in which the execution state of the process is preserved. When the process is suspended, the process may be executed in the background. In an example, the timer may have a specified length (e.g., 5 seconds). For example, when the first application is an Internet browser, the electronic device 100 may perform operation 1110.

In operation 1120, the electronic device 100 may determine whether a specified input is received before the timer expires. For example, the specified input may include a transition to the unfolded position or a change in a direction of the second display 162. When the electronic device 100 is unfolded again before the timer expires, the user may wish to continue using the first application. Before the expiration of the timer, the direction that the second display 162 of the electronic device 100 faces may be changed to the first direction that the first flexible display 161 faces in the unfolded position. In this case, the user may wish to continue using the first application through the second display 162 by turning the electronic device 100 upside down.

When the specified input is received (e.g., the operation 1120—YES), in operation 1125, the electronic device 100 may provide the contents through the first flexible display 161 or the second display 162. For example, the electronic device 100 may be unfolded again before the expiration of the timer. In this case, the electronic device 100 may present the contents of the first application through the first flexible display 161. For example, when the orientation of the electronic device 100 is changed such that the direction of the second display 162 corresponds to the first direction (e.g., the first direction 701 of FIG. 7) before the expiration of the timer, the electronic device 100 may provide the contents of the first application through the second display 162.

If the specified input is not received (e.g., operation 1120—NO), in operation 1130, the electronic device 100 may terminate the process of the first application. For example, the electronic device 100 may terminate the process when the timer expires.

FIG. 12 illustrates one example of a transition to a half-folded position according to an embodiment of the disclosure.

Referring to FIGS. 1 and 12, according to an embodiment, the electronic device 100 may provide service continuity in case of transitioning to the half-folded position. With respect to FIGS. 1, 2A to 2C, and 3 to 11, methods for providing service continuity when transitioning from the unfolded position to the folded position have been described. However, even when transitioning from the unfolded position to the half-folded position, the electronic device 100 may perform the above-described methods.

For example, the user 1299 may execute a camera application by using the electronic device 100 in the unfolded position. The electronic device 100 may provide contents (e.g., a preview screen and a UI) of the camera application through the first flexible display 161. The user 1299 may take a selfie by using the front camera 181. In the unfolded position, the electronic device 100 may identify a first direction 1201 (e.g., the first direction 701 of FIG. 7) by using the sensor circuitry 176. The electronic device 100 may identify the user 1299 from an image obtained by using the front camera 181. For example, the electronic device 100 may identify the user 1299 based on the image recognition.

The user 1299 may transition the electronic device 100 to the half-folded position. The electronic device 100 may sense a position transition using the sensor circuitry 176. The electronic device 100 may determine whether a specified condition is satisfied (e.g., the operation 515 of FIG. 5) in response to the position transition.

For example, in the half-folded position, the electronic device 100 may identify a second direction 1202 (e.g., the second direction 702 of FIG. 7) using the sensor circuitry 176. The electronic device 100 may identify the user 1299 from an image obtained using the rear camera 182.

In an example, the electronic device 100 may determine that the specified condition is satisfied when the first direction 1201 corresponds to the second direction 1202. In an example, the electronic device 100 may determine that the specified condition is satisfied when the first direction (1201) and the second direction are corresponding to each other and the user 1299 is identified from an image obtained using the rear camera 182. When the specified condition is satisfied, the electronic device 100 may provide the contents of the camera application through the second display 162 (e.g., the operation 520 of FIG. 5). The electronic device 100 may provide images obtained using the rear camera 182 through the second display 162.

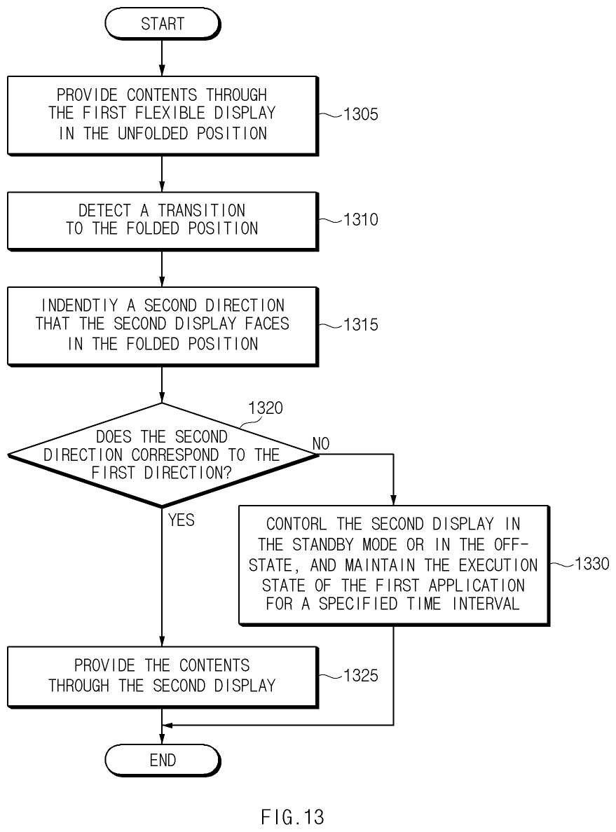

FIG. 13 is a flowchart of a contents providing method according to an embodiment of the disclosure.

Referring to FIG. 13, an electronic device (e.g., the electronic device 100 of FIG. 1, the electronic device 100a of FIGS. 2A to 2C, and the electronic device 100b of FIG. 3) according to an embodiment may provide contents based on a transition to the folded position. A housing of the electronic device may include a first housing (e.g., the first housing 111 of FIGS. 2A to 2C, and 3) and a second housing (e.g., the second housing 112 of FIGS. 2A to 2C) rotatably engaged with the first housing between the folded position and the unfolded position. The electronic device may include a first flexible display (e.g., the first flexible display 161 of FIG. 1) visible from a front side of the housing in the unfolded position and a second display (e.g., the second display 162 of FIG. 1) visible from the rear side of the housing in the unfolded position. The electronic device may include at least one sensor circuitry (e.g., the sensor circuitry 176 of FIG. 1) configured to detect a transition between the folded position and the unfolded position of the housing and detect a direction of the housing. The electronic device may include the first flexible display, the second display, and a processor (e.g., the processor 120 of FIG. 1) electrically connected to at least one sensor circuitry. The electronic device may include memory (e.g., the memory 130 of FIG. 1) electrically connected to the processor. The memory may store instructions that, when executed by the processor, cause the processor to perform the operations described below.

In operation 1305, the electronic device may provide contents through the first flexible display in the unfolded position. For example, the electronic device may provide contents corresponding to a first application by executing the first application. The operation 1305 may correspond to the operation 505 of FIG. 5.

In operation 1310, the electronic device may detect a transition to the folded position. The electronic device may detect the transition from the unfolded position to the folded position of the electronic device using at least one sensor circuitry. For example, the operation 1310 may correspond to the operation 510 of FIG. 5.

In operation 1315, the electronic device may identify a second direction in which the second display faces in the folded position. For example, the electronic device may acquire a first direction (e.g., the first direction 701 of FIG. 7) using at least one sensor at a time point at which transition from the unfolded position to the folded position starts. The electronic device may acquire the second direction (e.g., the second direction 702 of FIG. 7) using at the least one sensor at a time point at which the transition from the unfolded position to the folded position is completed. For example, the electronic device may acquire the first direction and the second direction according to the methods described above with reference to FIGS. 6 and 7.

In operation 1320, the electronic device may determine whether the second direction corresponds to the first direction (e.g., operation 515 of FIG. 5). When an angle between the first direction and the second direction is within a specified angle, the first direction may correspond to the second direction. When the first direction and the second direction are substantially identical, the first direction may correspond to the second direction.

When the second direction corresponds to the first direction (e.g., the operation 1320—YES), in operation 1325, the electronic device may provide the contents through the second display. For example, the operation 1320 may correspond to the operation 520 of FIG. 5.

When the second direction does not correspond to the first direction (e.g., the operation 1320—NO), in operation 1330, the electronic device may control the second display to be in the standby state or the off-state and maintain the execution state of the first application for a specified time interval. For example, the operation 1330 may correspond to the operation 525 of FIG. 5. When the second direction does not correspond to the first direction and the first application is not the specified application, the electronic device may control the second display in the standby state or the off-state and start a timer corresponding to the specified time interval (e.g., the operation 1110 of FIG. 11). When the second direction does not correspond to the first direction and the first application is the specified application, the electronic device may control the second display to be in the stand by state or the off-state and output audio contents corresponding to the first application (e.g., operation 1115 of FIG. 11). When a specified input is not received within the specified time interval, the electronic device may terminate the first application (e.g., the operation 1130 of FIG. 11).

For example, when the specified input is received within the specified time interval, the electronic device may provide contents corresponding to the first application through the second display (e.g., the operation 1125 of FIG. 11). The specified input may include a change of a direction in which the second display faces to a direction corresponding to the first direction after the transition to the folded position.

For example, when the specified input is received within a specified time period, the electronic device may provide the contents corresponding to the first application through the first flexible display (e.g., the operation 1125 of FIG. 11). The specified input may include a transition of the housing from the folded position to the unfolded position after the transition to the folded position.

In an example, the at least one sensor circuitry may be configured to sense an altitude of the electronic device. The electronic device may terminate the first application if a difference between a first altitude before the transition to the folded position and a second altitude after the transition to the folded position is greater than or equal to a specified value.

In one example, the at least one sensor circuitry may be configured to sense gripping of the electronic device. The electronic device may terminate the first application when the second housing or a surface on which the second display is located is identified as being gripped after the transition to the folded position.

In an example, the at least one sensor circuitry may be configured to detect blocking of the second display. The electronic device may terminate the first application if at least a portion of the second display is identified as being blocked after the transition to the folded position.

FIG. 14 is a block diagram illustrating an electronic device in a network environment according to an embodiment of the disclosure.

Referring to FIGS. 14, an electronic device 1401 in a network environment 1400 may communicate with an electronic device 1402 via a first network 1498 (e.g., a short-range wireless communication network), or at least one of an electronic device 1404 or a server 1408 via a second network 1499 (e.g., a long-range wireless communication network). According to an embodiment, the electronic device 1401 may communicate with the electronic device 1404 via the server 1408. According to an embodiment, the electronic device 1401 may include a processor 1420, memory 1430, an input module 1450, a sound output module 1455, a display module 1460, an audio module 1470, a sensor module 1476, an interface 1477, a connecting terminal 1478, a haptic module 1479, a camera module 1480, a power management module 1488, a battery 1489, a communication module 1490, a subscriber identification module (SIM) 1496, or an antenna module 1497. In some embodiments, at least one of the components (e.g., the connecting terminal 1478) may be omitted from the electronic device 1401, or one or more other components may be added in the electronic device 1401. In some embodiments, some of the components (e.g., the sensor module 1476, the camera module 1480, or the antenna module 1497) may be implemented as a single component (e.g., the display module 1460).

The processor 1420 may execute, for example, software (e.g., a program 1440) to control at least one other component (e.g., a hardware or software component) of the electronic device 1401 coupled with the processor 1420, and may perform various data processing or computation. According to one embodiment, as at least part of the data processing or computation, the processor 1420 may store a command or data received from another component (e.g., the sensor module 1476 or the communication module 1490) in volatile memory 1432, process the command or the data stored in the volatile memory 1432, and store resulting data in non-volatile memory 1434. According to an embodiment, the processor 1420 may include a main processor 1421 (e.g., a central processing unit (CPU) or an application processor (AP)), or an auxiliary processor 1423 (e.g., a graphics processing unit (GPU), a neural processing unit (NPU), an image signal processor (ISP), a sensor hub processor, or a communication processor (CP)) that is operable independently from, or in conjunction with, the main processor 1421. For example, when the electronic device 1401 includes the main processor 1421 and the auxiliary processor 1423, the auxiliary processor 1423 may be adapted to consume less power than the main processor 1421, or to be specific to a specified function. The auxiliary processor 1423 may be implemented as separate from, or as part of the main processor 1421.

The auxiliary processor 1423 may control at least some of functions or states related to at least one component (e.g., the display module 1460, the sensor module 1476, or the communication module 1490) among the components of the electronic device 1401, instead of the main processor 1421 while the main processor 1421 is in an inactive (e.g., sleep) state, or together with the main processor 1421 while the main processor 1421 is in an active state (e.g., executing an application). According to an embodiment, the auxiliary processor 1423 (e.g., an image signal processor or a communication processor) may be implemented as part of another component (e.g., the camera module 1480 or the communication module 1490) functionally related to the auxiliary processor 1423. According to an embodiment, the auxiliary processor 1423 (e.g., the neural processing unit) may include a hardware structure specified for artificial intelligence model processing. An artificial intelligence model may be generated by machine learning. Such learning may be performed, e.g., by the electronic device 1401 where the artificial intelligence is performed or via a separate server (e.g., the server 1408). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1430 may store various data used by at least one component (e.g., the processor 1420 or the sensor module 1476) of the electronic device 1401. The various data may include, for example, software (e.g., the program 1440) and input data or output data for a command related thereto. The memory 1430 may include the volatile memory 1432 or the non-volatile memory 1434.

The program 1440 may be stored in the memory 1430 as software, and may include, for example, an operating system (OS) 1442, middleware 1444, or an application 1446.

The input module 1450 may receive a command or data to be used by another component (e.g., the processor 1420) of the electronic device 1401, from the outside (e.g., a user) of the electronic device 1401. The input module 1450 may include, for example, a microphone, a mouse, a keyboard, a key (e.g., a button), or a digital pen (e.g., a stylus pen).

The sound output module 1455 may output sound signals to the outside of the electronic device 1401. The sound output module 1455 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1460 may visually provide information to the outside (e.g., a user) of the electronic device 1401. The display module 1460 may include, for example, a display, a hologram device, or a projector and control circuitry to control a corresponding one of the display, hologram device, and projector. According to an embodiment, the display module 1460 may include a touch sensor adapted to detect a touch, or a pressure sensor adapted to measure the intensity of force incurred by the touch.

The audio module 1470 may convert a sound into an electrical signal and vice versa. According to an embodiment, the audio module 1470 may obtain the sound via the input module 1450, or output the sound via the sound output module 1455 or a headphone of an external electronic device (e.g., an electronic device 1402) directly (e.g., wiredly) or wirelessly coupled with the electronic device 1401.

The sensor module 1476 may detect an operational state (e.g., power or temperature) of the electronic device 1401 or an environmental state (e.g., a state of a user) external to the electronic device 1401, and then generate an electrical signal or data value corresponding to the detected state. According to an embodiment, the sensor module 1476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1477 may support one or more specified protocols to be used for the electronic device 1401 to be coupled with the external electronic device (e.g., the electronic device 1402) directly (e.g., wiredly) or wirelessly. According to an embodiment, the interface 1477 may include, for example, a high definition multimedia interface (HDMI), a universal serial bus (USB) interface, a secure digital (SD) card interface, or an audio interface.

A connecting terminal 1478 may include a connector via which the electronic device 1401 may be physically connected with the external electronic device (e.g., the electronic device 1402). According to an embodiment, the connecting terminal 1478 may include, for example, a HDMI connector, a USB connector, a SD card connector, or an audio connector (e.g., a headphone connector).

The haptic module 1479 may convert an electrical signal into a mechanical stimulus (e.g., a vibration or a movement) or electrical stimulus which may be recognized by a user via his tactile sensation or kinesthetic sensation. According to an embodiment, the haptic module 1479 may include, for example, a motor, a piezoelectric element, or an electric stimulator.

The camera module 1480 may capture a still image or moving images. According to an embodiment, the camera module 1480 may include one or more lenses, image sensors, image signal processors, or flashes.

The power management module 1488 may manage power supplied to the electronic device 1401. According to one embodiment, the power management module 1488 may be implemented as at least part of, for example, a power management integrated circuit (PMIC).

The battery 1489 may supply power to at least one component of the electronic device 1401. According to an embodiment, the battery 1489 may include, for example, a primary cell which is not rechargeable, a secondary cell which is rechargeable, or a fuel cell.

The communication module 1490 may support establishing a direct (e.g., wired) communication channel or a wireless communication channel between the electronic device 1401 and the external electronic device (e.g., the electronic device 1402, the electronic device 1404, or the server 1408) and performing communication via the established communication channel. The communication module 1490 may include one or more communication processors that are operable independently from the processor 1420 (e.g., the application processor (AP)) and supports a direct (e.g., wired) communication or a wireless communication. According to an embodiment, the communication module 1490 may include a wireless communication module 1492 (e.g., a cellular communication module, a short-range wireless communication module, or a global navigation satellite system (GNSS) communication module) or a wired communication module 1494 (e.g., a local area network (LAN) communication module or a power line communication (PLC) module). A corresponding one of these communication modules may communicate with the external electronic device via the first network 1498 (e.g., a short-range communication network, such as Bluetooth™, wireless-fidelity (Wi-Fi) direct, or infrared data association (IrDA)) or the second network 1499 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1492 may identify and authenticate the electronic device 1401 in a communication network, such as the first network 1498 or the second network 1499, using subscriber information (e.g., international mobile subscriber identity (IMSI)) stored in the subscriber identification module 1496.

The wireless communication module 1492 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1492 may support a high-frequency band (e.g., the millimeter wave (mmWave) band) to achieve, e.g., a high data transmission rate. The wireless communication module 1492 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1492 may support various requirements specified in the electronic device 1401, an external electronic device (e.g., the electronic device 1404), or a network system (e.g., the second network 1499). According to an embodiment, the wireless communication module 1492 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 1497 may transmit or receive a signal or power to or from the outside (e.g., the external electronic device) of the electronic device 1401. According to an embodiment, the antenna module 1497 may include an antenna including a radiating element composed of a conductive material or a conductive pattern formed in or on a substrate (e.g., a printed circuit board (PCB)). According to an embodiment, the antenna module 1497 may include a plurality of antennas (e.g., array antennas). In such a case, at least one antenna appropriate for a communication scheme used in the communication network, such as the first network 1498 or the second network 1499, may be selected, for example, by the communication module 1490 (e.g., the wireless communication module 1492) from the plurality of antennas. The signal or the power may then be transmitted or received between the communication module 1490 and the external electronic device via the selected at least one antenna. According to an embodiment, another component (e.g., a radio frequency integrated circuit (RFIC)) other than the radiating element may be additionally formed as part of the antenna module 1497.

According to various embodiments, the antenna module 1497 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1401 and the external electronic device 1404 via the server 1408 coupled with the second network 1499. Each of the electronic devices 1402 or 1404 may be a device of a same type as, or a different type, from the electronic device 1401. According to an embodiment, all or some of operations to be executed at the electronic device 1401 may be executed at one or more of the external electronic devices 1402 or 1404, or the server 1408. For example, if the electronic device 1401 should perform a function or a service automatically, or in response to a request from a user or another device, the electronic device 1401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1401. The electronic device 1401 may provide the outcome, with or without further processing of the outcome, as at least part of a reply to the request. To that end, a cloud computing, distributed computing, mobile edge computing (MEC), or client-server computing technology may be used, for example. The electronic device 1401 may provide ultra low-latency services using, e.g., distributed computing or mobile edge computing. In another embodiment, the external electronic device 1404 may include an internet-of-things (IoT) device. The server 1408 may be an intelligent server using machine learning and/or a neural network. According to an embodiment, the external electronic device 1404 or the server 1408 may be included in the second network 1499. The electronic device 1401 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1440) including one or more instructions that are stored in a storage medium (e.g., internal memory 1436 or external memory 1438) that is readable by a machine (e.g., the electronic device 1401). For example, a processor (e.g., the processor 1420) of the machine (e.g., the electronic device 1401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, the electronic device comprising:
a housing comprising a first housing and a second housing rotatably engaged with the first housing between a folded position and an unfolded position;
a first flexible display visible from a front side of the housing at the unfolded position;
a second display visible from a rear side of the housing at the unfolded position;
at least one sensor circuitry configured to detect a transition between the folded position and the unfolded position of the housing and to detect a direction of the housing;
memory storing instructions; and
at least one processor electrically communicatively coupled to the first flexible display, the second display, the at least one sensor circuitry and the memory,
wherein the instructions, when executed by the at least one processor individually or collectively, cause the electronic device to:
provide content corresponding to a first application through the first flexible display by executing the first application at the unfolded position,
while providing the content through the first flexible display, detect a transition of the housing from the unfolded position to the folded position using the at least one sensor circuitry,
identifying, based on the detecting of the transition, a second direction in which the second display is facing in the folded position,
based on the second direction corresponding to a first direction in which the front surface of the housing faces before the transition to the folded position, provide the content corresponding to the first application through the second display, and
based on the second direction not corresponding to the first direction, control the second display to be in a standby state or an off-state and maintain an execution state of the first application for a specified time interval.

2. The electronic device of claim 1, wherein the instructions, when executed by the at least one processor individually or collectively, further cause the electronic device to terminate the first application when a specified input is not received within the specified time interval.

3. The electronic device of claim 2,
wherein the instructions, when executed by the at least one processor individually or collectively, further cause the electronic device to provide content corresponding to the first application through the second display in case that the specified input is received within the specified time interval, and
wherein the specified input includes changing a direction, in which the second display faces, to a direction corresponding to the first direction after the transition to the folded position.

4. The electronic device of claim 2, further comprising:
wherein the instructions, when executed by the at least one processor individually or collectively, further cause the electronic device to provide content corresponding to the first application through the first flexible display in case that the specified input is received within the specified time interval, and
wherein the specified input includes a transition of the housing from the folded position to the unfolded position after the transition to the folded position.

5. The electronic device of claim 1, further comprising:
wherein the instructions, when executed by the at least one processor individually or collectively, further cause the electronic device to:
in case that the second direction does not correspond to the first direction and the first application is not a specified application, control the second display to be in the standby state or the off-state and start a timer corresponding to the specified time interval, and
in case that the second direction does not correspond to the first direction and the first application is the specified application, control the second display to be in the standby state or the off-state and output audio content corresponding to the first application.

6. The electronic device of claim 1, wherein the instructions, when executed by the at least one processor individually or collectively, further cause the electronic device to:
at a time point in which the transition from the unfolded position to the folded position starts, acquire the first direction by using the at least one sensor circuitry; and
at a time point in which the transition from the unfolded position to the folded position is completed, acquire the second direction by using the at least one sensor circuitry.

7. The electronic device according to claim 1,
wherein the at least one sensor circuitry is further configured to detect altitudes of the electronic device, and
wherein the instructions, when executed by the at least one processor individually or collectively, further cause the electronic device to terminate the first application when a difference between a first altitude before the transition from the unfolded position to the folded position and a second altitude after the transition from the unfolded position to the fold position is greater than or equal to a specified value.

8. The electronic device according to claim 1,
wherein the at least one sensor circuitry is further configured to detect a grip on the electronic device, and
wherein the instructions, when executed by the at least one processor individually or collectively, further cause the electronic device to terminate the first application in case that the second housing or a surface on which the second display is located is identified as being gripped after the transition from the unfolded position to the folded position.

9. The electronic device according to claim 1,
wherein the at least one sensor circuitry is further configured to detect blocking of the second display, and
wherein the instructions, when executed by the at least one processor individually or collectively, further cause the electronic device to terminate the first application in case that at least a portion of the second display is blocked after the transition from the unfolded position to the folded position.

10. A method performed by an electronic device with a housing comprising a first housing and a second housing rotatably engaged with the first housing, the method comprising:
providing content corresponding to a first application through a first flexible display visible from a front side of the housing by executing the first application at a unfolded position of the housing;
detecting, while providing the content through the first flexible display, a transition of the housing from the unfolded position to a folded position;
identifying, based on detection of the transition to the folded position, a second direction in which a second display disposed on a rear surface of the second housing faces in the folded position;
based on the second direction corresponding to a first direction in which the front surface of the housing faces before the transition to the folded position, providing content corresponding to the first application through the second display; and
based on the second direction not corresponding to the first direction, controlling the second display to be in a standby state or an off-state and maintaining an execution state of the first application for a specified time interval.

11. The method of claim 10, further comprising:
terminating the first application in case that a specified input is not received within the specified time interval.

12. The method of claim 11, further comprising:
providing content corresponding to the first application through the second display in case that the specified input is received within the specified time interval,
wherein the specified input includes changing a direction, in which the second display faces, to a direction corresponding to the first direction after the transition to the folded position.

13. The method of claim 11, further comprising:
providing content corresponding to the first application through the first flexible display in case that the specified input is received within the specified time interval,
wherein the specified input includes a transition of the housing from the folded position to the unfolded position after the transition to the folded position.

14. The method of claim 10, further comprising:
in case that the second direction does not correspond to the first direction and the first application is not a specified application, controlling the second display to be in a standby state or an-off state and starting a timer corresponding to the specified time interval; and
in case that the second direction does not correspond to the first direction and the first application is the specified application, controlling the second display to be in a standby state or an off state and outputting audio content corresponding to the first application.

15. One or more non-transitory computer-readable media storing one or more computer programs including computer-executable instructions that, when executed by one or more processors of an electronic device individually or collectively with a housing including a first housing and a second housing rotatably engaged with the first housing, cause the electronic device to perform operations, the operations comprising:
providing content corresponding to a first application through a first flexible display visible from a front side of the housing at an unfolded position by executing the first application at the unfolded position of the housing;
detecting a transition of the housing from the unfolded position to a folded position while providing the content through the first flexible display;
based on detection of the transition to the folded position, identifying a second direction in which a second display disposed at a rear surface of the second housing faces in the folded position;
based on the second direction corresponding to a first direction, in which a front surface of the housing faces before the transition to the folded position, providing content corresponding to the first application through the second display; and
based on the second direction not corresponding to the first direction, controlling the second display to be in a standby state or an off-state, and maintaining an execution state of the first application for a specified time interval.

16. The one or more non-transitory computer-readable storage media of claim 15, the operations further comprising terminating the first application in case that a specified input is not received within the specified time interval.

17. The one or more non-transitory computer-readable storage media of claim 16, the operations further comprising:
providing content corresponding to the first application through the second display in case that the specified input is received within the specified time interval,
wherein the specified input includes changing a direction, in which the second display faces, to a direction corresponding to the first direction after the transition to the folded position.

18. The one or more non-transitory computer-readable storage media of claim 16, the operations further comprising:
providing content corresponding to the first application through the first flexible display in case that the specified input is received within the specified time interval,
wherein the specified input includes a transition of the housing from the folded position to the unfolded position after the transition to the folded position.

19. The one or more non-transitory computer-readable storage media of claim 15, the operations further comprising:
in case that the second direction does not correspond to the first direction and the first application is not a specified application, controlling the second display to be in a standby state or an-off state and starting a timer corresponding to the specified time interval; and
in case that the second direction does not correspond to the first direction and the first application is the specified application, controlling the second display to be in a standby state or an off state and outputting audio content corresponding to the first application.
